(19) United States
(12) Patent Application Publication
(10) Pub. No.: US 2012/0153884 A1
(43) Pub. Date: Jun. 21, 2012

(54) Integrated motor controller system

(75) Inventors: Robert W. Lindsey, Washington, IL (US); Eric M. Andris, Chillicothe, IL (US); James Portscheller, Sparland, IL (US); Mike Portscheller, Dunlap, IL (US)

(73) Assignee: CATERPILLAR INC., Peoria, IL (US)

(21) Appl. No.: 12/974,727

(22) Filed: Dec. 21, 2010

(51) Int. Cl. H02P 23/00

(52) U.S. Cl. 318/500

(57) ABSTRACT

A controller for managing electrical power storage in a machine having an electric energy storage device and an electric motor comprises a gate drive stage for providing gate signals to one or more power electronics elements, as well as a control processor adapted to generate gate signals and supply the generated gate signals to the gate drive stage for controlling the one or more power electronics elements. The gate signals control the one or more power electronics elements to power the motor windings in a drive mode of operation and to charge the electric energy storage device in a charging mode of operation. In either mode, the motor windings are used as conductors or inductive elements.

### TECHNICAL FIELD

This patent disclosure relates generally to electric motor control, and more particularly to a system for managing electrical power use and storage.

### BACKGROUND

Many systems and devices require the storage and usage of electrical power. For example, a complex electric locomotive generates, stores, and utilizes electrical power for purposes of propulsion. Similarly, an electrical device as simple as a golf cart also requires the storage (charging) and use (driving) of electrical power. As another example, consider an electrical industrial machine with onboard energy storage, e.g., a battery bank, and one or more electrical motors for driving implements or traction elements.

Although the fundamental issues of electrical energy storage are common to these various types of systems, the charging of such devices has to date required a complex array of customized chargers to allow each system to receive the appropriate voltage and current for charging. This has caused expense and confusion due to the sheer number and diversity of required charging devices. Moreover, for devices requiring higher power supply voltages for charging, the safety of personnel can become an issue if exacting and expensive precautionary measures are not followed.

Moreover, within any given chargeable electrically powered system, there is often a need for multiple power converters to operate traction devices, control systems, safety systems, etc. These multiple systems result in a large number of failure points and failure modes due to increased interconnections of multiple components. This in turn may negatively affect the overall reliability of the machine.

While the disclosed principles herein are directed at least in part to overcoming one or more disadvantages, noted or otherwise, it will be appreciated that the innovation herein is defined by the attached claims without to regard to whether and to what extent the specifically claimed embodiment overcomes one or more of the noted problems in the existing technology. Moreover, it will be appreciated that any discussion herein of any reference or publication is merely intended as an invitation to study the indicated reference itself, and is not intended to replace or supplement the actual reference. To the extent that the discussion of any reference herein is inconsistent with that reference, it will be appreciated that the reference itself is conclusive as to its teachings.

### SUMMARY

In one aspect, the disclosed system includes a controller for managing electrical power storage and use in a machine having an electric energy storage device and an electric motor. The motor has a plurality of motor windings, and the machine further includes a charge jack connectable to an external power source. The controller comprises a gate drive stage for providing gate signals to one or more power electronics elements, as well as a control processor adapted to generate gate signals and supply the generated gate signals to the gate drive stage for controlling the one or more power electronics elements. The gate signals are configured in an embodiment to control the one or more power electronics elements to drive the motor windings in a drive mode of operation. The gate signals are further configured to charge the electric energy storage device in a charging mode of operation. In both modes, the gate signals are adapted to utilize the motor windings as inductive elements or conductors either to transform power provided by the external power source into a form suitable for charging the electric energy storage device or to transform power provided by the electric energy storage device into fields for driving the motor.

It is to be understood that both the foregoing general description and the following detailed description are exemplary and explanatory only and are not restrictive of the invention. Further aspects and features of the disclosed principles will be appreciated from the following detailed description and the accompanying drawings, of which:

### BRIEF DESCRIPTION OF THE DRAWINGS

FIG. 1 is a circuit diagram of a charging and energy utilization system in accordance with the described principles;

FIG. 2 is a schematic modular diagram of a controller in accordance with the described principles; and

FIG. 3 is a circuit schematic diagram illustrating a configuration of the integrated motor controller system in a hybrid electric industrial or construction machine, in an application including a hydraulic pump motor in accordance with the described principles.

### DETAILED DESCRIPTION

This disclosure relates to a system that allows integrated control, monitoring and diagnostic functions for an electric motor or electric machinery such as an electric utility vehicle, electric work machine, cooling system, pumping system, uninterruptible power supply, traction system, transportation machine, or other electrically driven machine that utilizes the conversion of stored DC power to commutated AC power.

Additionally, the described principles provide a system of battery management utilizing an integrated architecture. The system provides support functions for powering and controlling an electric machine or machinery, including ground fault detection, ground fault interruption, battery charging, battery monitoring, temperature monitoring, power semiconductor driving, current and voltage sensing, system diagnostics and self testing, safety circuit inclusion and functions, data link communications, and power conversion and regulation.

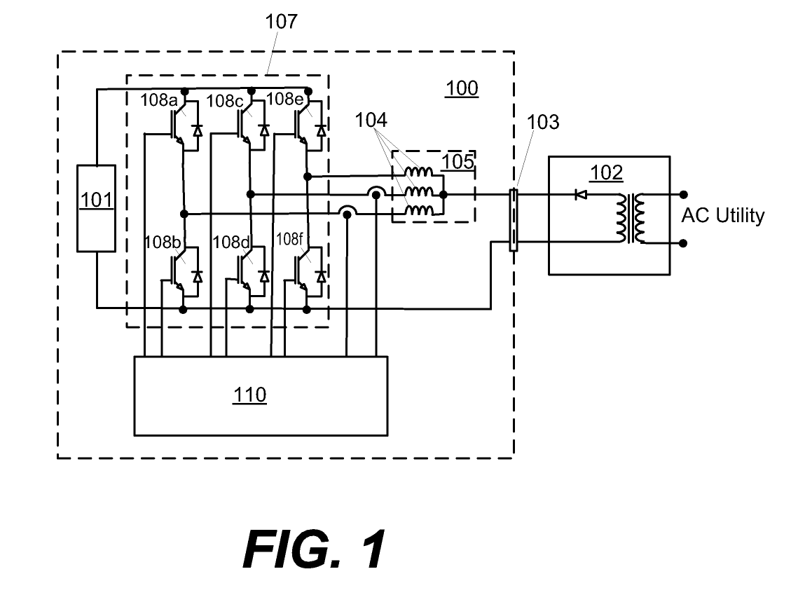

In overview, FIG. 1 shows an integrated motor controller architecture according to an embodiment, having improved safety and cost efficiency, wherein the motor controller itself also acts as a charge controller. The illustrated controller architecture 100 is shown within a usage environment including an electrical energy storage device, e.g., battery 101, as well as a step-down transformer rectifier 102. The step-down transformer rectifier 102 is linked to utility power, e.g., at 110 VAC or 220 VAC, and acts to reduce the voltage to a safe rectified voltage, e.g., 50 V magnitude. The step-down transformer rectifier 102 could be external or could be internal to the machine.

When charging, the output of the step-down transformer rectifier 102 provides a power input to the remainder of the system via a charge jack 103. The charge jack 103 supplies the rectified voltage to the windings 104 of an electric motor 105 (i.e., to the motor winding common terminals). In conjunction with the remainder of the system, as will be described later herein, this allows the motor windings 104 to act as inductive elements or conductor during the charging of the battery 101.

A power electronics package 107 bridges the windings 104 and charge jack 103 to the battery 101. The power electronics package 107 includes six power transistors 108a-f. In the illustrated embodiment, the six power transistors 108a-f are IGBTs, although it will be appreciated that other power electronic elements may be used instead. Each power transistor 108a-f is paired with a diode 109a-f connecting from the IGBT collector to its emitter.

Each power transistor pair 108a-b, 108c-d, and 108e-f is tied to one electric motor winding element. The gates of the power transistors 108a-f are linked to and controlled by a controller 110 via gate driver stages, e.g., 6 channels in the illustrated configuration. The controller 110 is also connected so as to detect the current and/or voltage associated with a plurality of the windings 104.

In this configuration, when the system 100 is used in a charging mode, external power is supplied into the system via the charge jack 103, through the motor windings 104 and the power transistors 108a-f. The controller 110 controls the transistor gates based upon the sensed winding voltage as well as the requirements and capabilities of the battery 101. For example, the controller 110 can manipulate the gate voltages to step up the voltage of the supplied power, such that even though the external source is at a safe voltage, the internal voltage may be stepped up considerably, e.g., to several hundred volts. Similarly, the voltage may be stepped down if appropriate. In the same way, the current limits of the battery are enforced by the controller such that the battery is not overheated or damaged.

In an electrical energy usage mode, e.g., when driving an electrically-powered transportation machine or using an electrically-powered implement, the controller 110 meters and modifies the energy coming from the battery 101, so as to meet the requirements of the motor, in keeping with any operator request. Thus, for example, if the operator signals the machine to halt, the controller 110 does not allow any significant energy to pass to the motor windings 104. However, when the operator requests power to the motor, the windings 104 are energized by the controller 100 via manipulation of the gates of the transistors 108a-f. Thus, the system utilizes the motor windings 104 in a static charging mode, a regenerative charging mode and a discharging mode.

With this arrangement, the controller 110 is able to accommodate different motor control methods or algorithms (waveforms, voltage, current, etc.) as well as different battery requirements (waveforms, voltage, current, etc.), and the two need not be the same. Thus, the same system can be used with many different types (lead acid, gel cell, lithium polymer, lithium ion, etc.) and configurations of batteries (single, multiple parallel bank, multiple series bank, combined parallel and series banks, etc.). This limits the number of different parts needed in manufacturing and maintaining such systems, and also eliminates the need to own and maintain multiple external charge systems for a fleet having various size and capacity machines.

Further, the design of the controller 110 allows each machine to maintain accurate state-of-charge data for the battery and to provide an optimized charging function, and to utilize a single battery charger to charge multiple machines that may contain different battery technologies. Moreover, the adaptable design of the controller 110 allows machines having such a controller to operate in the same facilities as older machines without such adaptability.

In an embodiment, the charge controller maintains charge cycle counts, voltages, currents and other data for trending battery performance and life expectancy. In a further embodiment, the controller 110 and power electronics package (semiconductor power stage) are easily replaced modularized components, such that spares may be easily obtained and quickly installed.

In an embodiment, the neutral points of the motor windings 104 are exposed to enable the connection configuration as described above. However, in an alternative embodiment, separate inductors are utilized in lieu of or in addition to the motor windings 104, allowing the controller 210 to operate as a switched-mode power converter such as a buck converter, boost converter, flyback converter, or other topology utilizing a switched power device. For example, controller 210 may operate a single phase traction motor with four IGBT transistors and additionally control a down converter using at least one IGBT transistor and a separate inductor to provide a regulated voltage source.

Although the illustrated configuration utilizes IGBTs for transistors 108a-f, it will be appreciated that the illustrated principles may also utilize other types of devices instead, e.g., MOSFETs, SCRs, and other solid state power devices. In this regard, it will be appreciated that the controller 110 comprises contains power supplies, signal isolators, and other circuits useful to directly drive power devices. Power devices may also contain gate drive components that are specific to the device. For example, an IGBT may contain a gate drive resistor, a pull down resistor, a zener clamp, a pulse transformer, a snubber network, or other components that are desired to be physically located near the IGBT.

In some applications, the gate driver may also be located at the IGBT along with power supplies and other components. In this case, the gate driver components in the controller 110 could further be removed or eliminated to reduce cost. In this way, the controller 110 may be used with or without the gate driver components. Moreover, gate drive channels that are not necessary for a certain application may be used for other applications if the applied load is within the gate driver specifications.

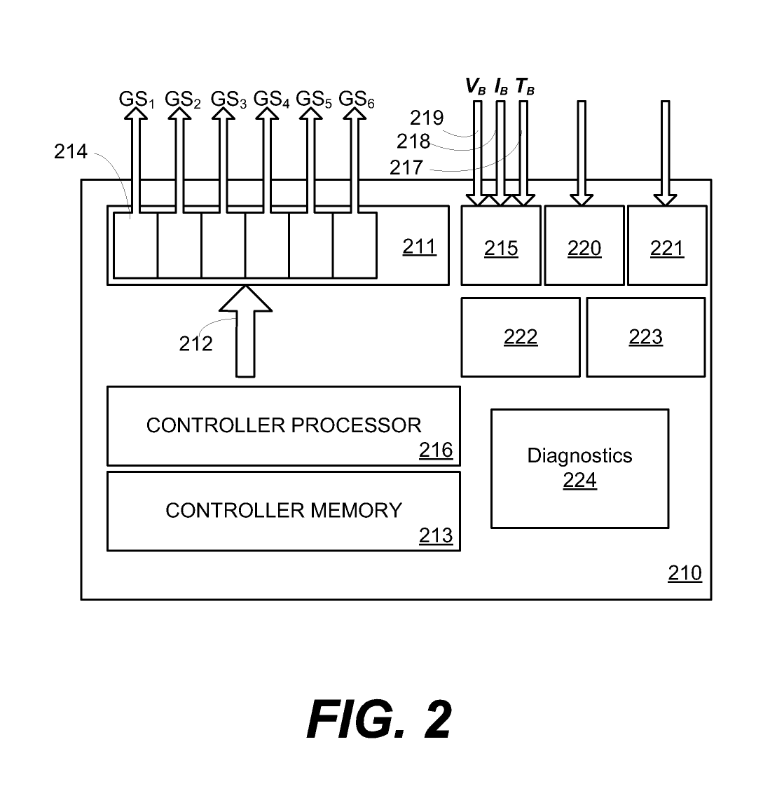

FIG. 2 is a more detailed module-level diagram showing the components of the controller 210 (110). As noted above, the controller 110 supplies the appropriate motor modulation (e.g., up to Up to 10 khz, and v/hz, SVM, etc.) To this end, a modulated control signal 212 is provided to the gate driver stage 211 for electric machine commutation. The carrier frequency of the modulation can be controlled and specifically optimized and limited for the application. A typical modulation frequency is 3 khz, but other frequencies may be employed. Modulation methods may be volts/hertz, space vector modulation, or other known modulation techniques.

The modulation method is a programmed function and may be change dynamically within the controller memory 213 as needed for the application. In an embodiment, the programmed modulation method also employs limiting functions, e.g., minimum pulse characteristics, maximum pulse characteristics, deadband intervals, fault signal management, control signal management, and diagnostic mode. It will be appreciated that modulation methods are also provided for battery charging, and not just for motoring operation.

As noted above, the controller 210 can provide both step up and step down functions. In the case of a step down, or down conversion, the controller 210 manipulates the power electronics gates via signal 212 and gate channels 214 within the gate driver stage 211 to produce gate signals GS₁, GS₂, GS₃, GS₄, GS₅, and GS₆ so as to transform a higher voltage to a lower voltage. For example, in an application that uses a 72 v battery, a power converter may convert the battery voltage to 12 v such that it may be used to energize lower voltage components such as electronic control modules, lights, electronic displays, relays, heaters, etc. The down converter is programmable via memory 213 to provide (i.e., to create via control of the gate signals GS₁-GS₆) a lower output voltage that can be optimized for the application within a range of, for example, 12 to 28 vdc. In an embodiment, the down power converter function is programmable to input voltages from, for example, 32 v to 150 vdc, depending upon the energy source voltage. The energy source may be a battery, a fuel cell, a capacitor, a rectifier system, a dc power supply, a utility grid, a photovoltaic system, a thermoelectric module, a chemical reactor, or any suitable power source.

The down converter function may also be programmed to limit current output and operate in a constant-voltage or constant current mode. Moreover, the down converter function also provides over-voltage, under-voltage, over-current, and over-temperature protection in an embodiment.

The controller 210 also provides energy source monitoring (ESM) of the power source in an embodiment via a power source monitor module 215, which may comprise dedicated internal circuitry and or functional programming stored within memory 213 and accessed and executed by processor 216. The ESM module 215 monitors voltage, current and temperature of the power source, e.g., battery 101, to detect and prevent damaging conditions. One voltage monitor channel 217, one current channel 218 and one temperature channel 219 may be provided, for receiving input reflecting the associated parameters. The ESM module 215 may be programmable to receive and employ power source characteristics, algorithms, maps to determine the state of available energy, power usage history, and so on.

In a further embodiment, the ESM data is communicated over a data link to a display device (not shown). For example, an application that uses a battery as a power source may have an indicator to reflect the battery state-of-charge, time remaining, amps, volts, hours, charge cycles or other measured, calculated, or predicted parameter associated with power source.

With respect to fault detection, the controller provides a ground fault monitoring module 220 as well as a motor fault monitoring module 221 in an embodiment. In particular, it is possible that faults may occur in the insulation system of the power distribution system, energy source, and electric machine conductors. The fault monitoring functions of these modules 220, 221 may be implemented as described in U.S. Pat. No. 7,459,914, assigned to the same assignee, and herein incorporated by reference in its entirety. This fault detection system reduces machine troubleshooting overhead and warns the machine operator of hazardous machine conditions.

As noted, the controller 210 includes one or more current sensor inputs for monitoring current in the electric machine conductors and energy source. Internal support circuitry and connections may be provided for typical current sensors such as hall effect sensors and shunt type current sensors (not shown). If current sensors are not required for the application, the current sensor support circuitry components may be omitted to reduce cost. Voltage sensor inputs are similarly provided.

As also noted, the controller 210 may include temperature sensor inputs for monitoring temperatures in the electric machine and energy source. In this connection, internal support circuitry and connections may be provided for typical temperature sensors such as hall RTD sensors and thermocouple sensors (not shown). If temperature sensors are not required for a given application, the temperature sensor support circuitry components may be omitted to reduce cost. In a further embodiment, the controller 210 also contains one or more internal temperature sensors 222 to monitor the internal temperature of the controller 210.

In yet a further embodiment, the controller 210 is programmed to monitor over-current (desat) in the power semiconductor stage, e.g., power transistors 108a-f. Support circuitry and connections are thus provided in this embodiment for typical desat signals associated with power semiconductors. If desat inputs are not required for the application, the support circuitry components may be omitted to reduce cost.

The controller 210 may also include a data link 223 for control, status and programming information. The data link in one embodiment is based on the J1939 standard and may include support for service tools.

The controller 210 is implemented in an embodiment as a software programmable device that can be updated using the data link 223 and service tools. Control signals such as motor speed or torque, braking torque, and machine operations are communicated over the data link 223 to the controller 210 from other machine controls. The data link 223 may also communicate with a wireless data link (not shown) to another system such as a dispatch center to transfer performance, maintenance, scheduling, and safety information. For example, in a busy work environment, a dispatch operator may need to alert machine operators of machines that need to be charged. The wireless data link signal may operate with a warning lamp on the machine to visually notify the operator.

In a further embodiment, the controller 210 architecture or programming includes a diagnostic module 224 or function to monitor and report operating conditions, faults, and limits of the machine or machinery. Diagnostic information may be communicated across the data link 223 to other system controls or logged internally as service information. For example a diagnostic message may contain information related to the status of a battery systems discharge rate, voltage or current.

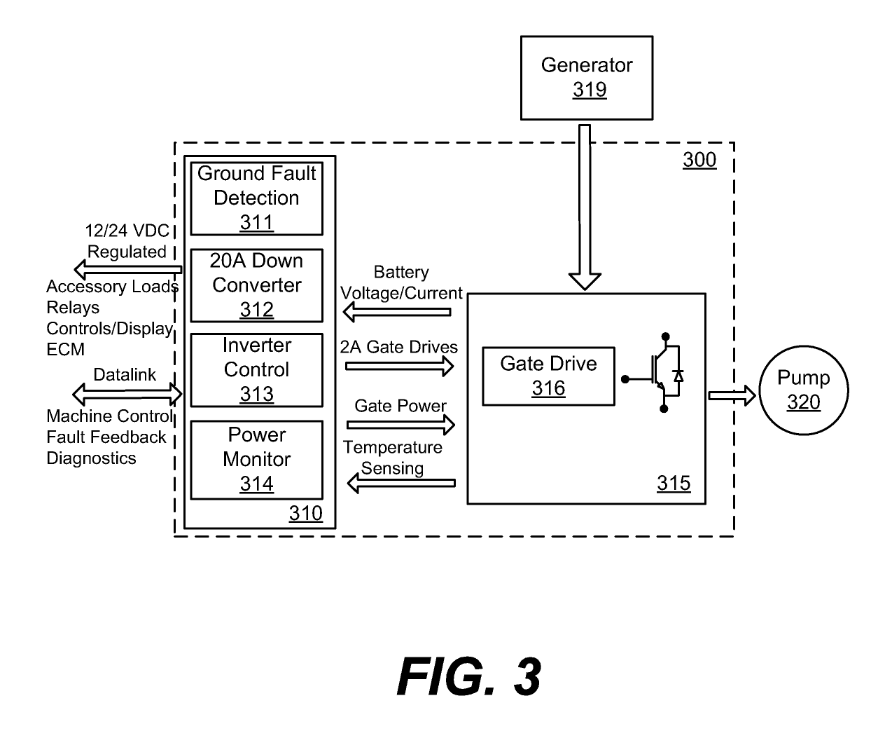

The schematic diagram of FIG. 3 illustrates one exemplary usage configuration of the described system. It will be appreciated that this configuration is merely an example intended to aid the reader and is not limiting with respect to the broader applicability of the described principles.

Turning to a specific example, FIG. 3 illustrates a configuration of the integrated motor controller system in a hybrid electric industrial or construction machine, in an application including a hydraulic pump motor powered by battery power. The illustrated configuration 300 includes the controller 310, including ground fault detection module 311, 20 A down converter 312, inverter control 313, and power monitor 314. The system 300 also includes the power stage 315, including gate drive 316. An engine-driven generator 319 feeds the battery, which then feeds the power stage 315, powering the pump 320. Pump 320 motor windings, controller 310 and charge jack connected to the pump windings (not shown), allow the power stage 315 to be used as a battery charge controller when the engine driven generator is not operating and the hybrid machine is connected to an external power source.

The gates of the power stage 315 are driven by the 2 A gate drive signal from the controller 310. The power stage 315 provides numerous power and data inputs to the controller 310, including a voltage/current power input, fault feedback data, phase current data, and temperature data. The controller 310 may in turn provide power to the remainder of the system and exchange data with the rest of the system. For example, a 12/24 VDC output power signal may be provided from the controller 310 to power accessory loads, relays, controls, and displays. Similarly, as discussed above the controller 310 may send and receive data via a data link signal, e.g., fault feedback data, diagnostic data, voltage commands, and current commands.

### INDUSTRIAL APPLICABILITY

The described principles are applicable to machines and devices requiring a motor controller, and can accommodate a wide range of load types and motor sizes. For example, even in a standard configuration, the described integrated motor controller can accommodate motor sizes from 5 kw to 50 kw. Additionally the integrated motor control system can be applied to recharge an energy source e.g., a lead acid battery, Lithium ion battery, etc., using some of the same components that as it uses to power the motor.

Examples of machines with which the system may be used include electric utility vehicles, electric work machines, fork lifts, traction systems, transportation machines, and other electrically driven machines. In an embodiment, the Integrated Motor Controller (IMC) is a power electronics driver module that provides many functions associated with electric machines and energy storage management into a single packaged component. This configuration allows a broad range of application for electric motor control at power levels from 2 kW to 50 kW and more. The power electronics components are independent of the control module in an embodiment and can be packaged separately to accommodate many different devices with different voltage and current ratings. For example, a forklift may use a 200 v, 100 amp MOSFET semiconductor with air cooling, while a high volume pump may use a 600 v, 50 amp IGBT semiconductor with liquid cooling. In a further embodiment, the integrated motor controller contains a Field Programmable Gate Array (FPGA), flashable memory, and may be field upgraded to accommodate a new energy source, motor technology, power stage, efficiency improvement, safety features, etc.

It will be appreciated, however, that the foregoing provides examples of the disclosed system and technique. As such, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A controller for managing electrical power storage and use in a machine having an electric energy storage device and a motor, the motor having a plurality of motor windings, the machine further having a charge jack connectable to an external power source, the controller comprising:
a gate drive stage for providing gate signals to one or more power electronics elements; and
a control processor adapted to generate gate signals and supply the generated gate signals to the gate drive stage for controlling the one or more power electronics elements, wherein the gate signals are configured to control the one or more power electronics elements to drive the motor windings in a drive mode of operation, and to charge the electric energy storage device in a charging mode of operation, wherein the gate signals used during the charging mode of operation are adapted to utilize the motor windings as inductive elements or conductors to transform power provided by the external power source into a form suitable for charging the electric energy storage device.

2. The controller for managing electrical power storage and use according to claim 1, further comprising a current sensor to measure a current in at least one of the plurality of motor windings.

3. The controller for managing electrical power storage and use according to claim 1, further comprising a diagnostics module for monitoring the machine and reporting one or more operating conditions and one or more faults.

4. The controller for managing electrical power storage and use according to claim 3, further comprising a data link, and wherein reporting one or more operating conditions and one or more faults includes communicating information regarding the one or more operating conditions and one or more faults across the data link.

5. The controller for managing electrical power storage and use according to claim 3, wherein reporting one or more operating conditions and one or more faults includes internally logging the one or more operating conditions and one or more faults as service information.

6. The controller for managing electrical power storage and use according to claim 3, wherein the one or more operating conditions relate to one or more of a discharge rate, voltage or current of the electric energy storage device.

7. The controller for managing electrical power storage and use according to claim 1, wherein the gate drive signals are configurable to transform the power provided by the external power source into a form suitable for any one of a plurality of types of electric energy storage device.

8. The controller for managing electrical power storage and use according to claim 1, wherein the one or more power electronics elements include a plurality of power transistors, and wherein the gate drive signals include a gate channel for each of the plurality of power transistors.

9. The controller for managing electrical power storage and use according to claim 1, wherein transforming the power provided by the external power source into a form suitable for charging the electric energy storage device comprises converting the voltage of the external power source.

10. The controller for managing electrical power storage and use according to claim 4, wherein the data link is configured to communicate wirelessly with a remote entity to receive an alert from the remote entity and to convey the alert to a user of the machine.

11. An electrically powered machine comprising:
an electrical energy storage system;
an electric motor having a plurality of motor windings; and
a controller for controlling charging of the electrical energy storage system from a power source and powering of the electric motor from the electrical energy storage system, the controller being configured to utilize the plurality of motor windings to control the motor as well as to condition the power provided by the power source.

12. The electrically powered machine according to claim 11, wherein the electrical energy storage system includes one or more batteries.

13. The electrically powered machine according to claim 11, wherein the power source is an electric utility line.

14. The electrically powered machine according to claim 11, wherein the power source is a generator.

15. The electrically powered machine according to claim 11, wherein the controller is a software programmable device.

16. The electrically powered machine according to claim 15, wherein the controller includes a data link and wherein the controller is programmable via the data link.

17. A method for controlling an electrically powered machine having a motor, with multiple motor windings, and an on-board battery, the method comprising:
charging the on-board battery with supplied electrical energy from an external power source by using one or more of the multiple motor windings as an inductive element to modify at least one of a voltage characteristic and a current characteristic of the supplied electrical energy; and
driving the motor by providing electrical energy from the on-board battery to the multiple motor windings.

18. The method for controlling an electrically powered machine according to claim 17, wherein modifying at least one of the voltage characteristic and the current characteristic of the supplied electrical energy includes down converting the supplied electrical energy to a lower voltage.

19. The method for controlling an electrically powered machine according to claim 17, wherein modifying at least one of the voltage characteristic and the current characteristic of the supplied electrical energy includes up converting the supplied electrical energy to a higher voltage.

20. The method for controlling an electrically powered machine according to claim 17, wherein the supplied electrical energy has a waveform characteristic, and wherein modifying at least one of the voltage characteristic and the current characteristic of the supplied electrical energy includes modifying the supplied electrical energy to have a different waveform characteristic.
